(19) United States
(12) Patent Application Publication
(10) Pub. No.: US 2013/0294404 A1
(43) Pub. Date: Nov. 7, 2013

(54) MOBILITY SUPPORTING METHOD OF A MOBILE ROUTER

(71) Applicant: Kang-Woon HONG, Seoul (KR)

(72) Inventor: Kang-Woon HONG, Seoul (KR)

(73) Assignee: Electronics and Telecommunications Research Institute, Daejeon-si (KR)

(21) Appl. No.: 13/669,967

(22) Filed: Nov. 6, 2012

(30) Foreign Application Priority Data
May 2, 2012 (KR) 10-2012-0046576

(51) Int. Cl. H04W 36/00

(52) U.S. Cl. 370/331

(57) ABSTRACT

A mobility supporting method of a mobile router is provided, and the method enables controlling mobility of a Mobile Node (MN) based on a network using the mobile router, which acts as a wireless base station and an access router without modifying a network infrastructure of an existing operator.

### CROSS-REFERENCE TO RELATED APPLICATION

This application claims the benefit under 35 U.S.C. §119(a) of Korean Patent Application Nos. 10-2012-0046576, filed on May 2, 2012, the entire disclosures of which are incorporated herein by references for all purposes.

### BACKGROUND

1. Field

The present invention is related to a mobility-supporting technology, and more specifically, a mobility supporting method of a mobile router.

2. Description of the Related Art

The conventional mobility control technology has not yet been actively utilized since it requires a Mobile Node (MN) to provide additional functions for mobility support, and the MN is configured with low specification and a limited battery lifetime.

In order to solve the above problem, a network-based mobility control technology has been suggested whereby the additional function for supporting mobility is performed on a network, minimizing the number of functions of the MN.

However, more effort and prior investment should be made in network infrastructures (for example, an access router and a wireless base station) in order to apply the network-based mobility control technology as well as an MN-based mobility control technology.

In addition, in terms of techniques, the conventional IP technology requires identification and a logical location of an MN, so that an IP address of the MN needs to be maintained for receiving a seamless service when the MN is moving. Therefore, the mobility control technology has been hardly applied.

For the above reasons, a method for applying the mobility control technology without modifying existing network infrastructures too much is urgently required. In addition, with the widespread of cloud services, new kinds of clients, such as Thin client and Zero client, have been introduced, and thus it is necessary to come up with a method for performing the mobility control function in a could system.

### SUMMARY

The present invention has been devised for the above reasons and aims to provide a mobility supporting method of a mobile router, which acts as a wireless base station and an access router and is capable of controlling mobility of a Mobile Node (MN) based on a network without modifying network infrastructures of an existing operator.

In addition, the present invention is also designed to provide a mobility supporting method of a mobile router in which a mobility control function is able to be performed in a cloud system so that the mobile router may be responsible for the mobility supporting function, thereby leading to reduced costs for hardware of an MN and development of various services in association of network-based services.

According to an exemplary embodiment of the present invention, a mobility supporting method of a mobile router includes configuring a tunnel for transmitting a control signal and data to a mobile agent configured to manage an access network to which a Mobile Node (MN), transmitting a Router Solicitation (RS) signal to the mobile agent and receiving a Router Advertisement (RA) signal from the mobile agent, caching the received RA signal to be transmitted to the MN upon receiving a RS signal from the corresponding MN, establishing a layer-2 (L2) association and performing an authentication process with respect to the MN; and, in response to an occurrence of a Media Independent Handover (MIH), processing the MIH.

In one general aspect of the present invention, the processing of the MIH may, in response to detecting a new MN, transmit a Location Report signal to the mobile agent.

In one general aspect of the present invention, the processing of the MIH may include, in response to the received RS signal from the MN, transmitting the RS signal to the mobile agent.

In one general aspect of the present invention, the mobility supporting method in the mobile router may further include performing a MIH follow-up operation to transmit to the MN the RA signal being cached by the mobile router.

In one general aspect of the present invention, an MIH follow-up operation may include, in response to a request for a Dynamic Host Configuration Protocol (DHCP) from the MN which has received the RA signal, receiving information on a Home of Address (HoA) and a Prefix from the mobile agent and transmitting the information on the HoA and the Prefix to the corresponding MN.

In one general aspect of the present invention, the MIH follow-up operation may include receiving the information on the HoA and the Prefix from the mobile agent using either an HOA update signal or the RA signal.

In one general aspect of the present invention, the mobile agent may transmit to a Home Location Register (HLR) either a Proxy Binding Update (PBU) signal comprising an L2 ID and a Care of Address (CoA) of the connected MN or a Location Registration Request signal.

In one general aspect of the present invention, the HLR may configure a binding entry including an L2 IDs list, a connected CoA and a Prefix of the MN and then transmit the binding entry to the mobile agent using either a Proxy Binding Acknowledgement (PBA) signal or a Location Registration Acknowledgement signal.

In one general aspect of the present invention, the mobile agent may be assigned with either the HoA or the Prefix to configure the binding entry including the L2 ID and information on the HOA or Prefix and transmit the information on the HOA or Prefix to the mobile router.

In one general aspect of the present invention, the MN may configure network information using the information on the HoA and the Prefix received from the mobile router.

According to an exemplary embodiment of the present invention, a mobility supporting method of a mobile router includes configuring a tunnel for transmitting a control signal and data to a mobile agent configured to manage an access network to which an MN is connected, establishing L2 association and performing an authentication process with respect to the MN and, in response to an occurrence of a Media Independent Handover (MIH), processing the MIH.

In another general aspect of the present invention, the processing of the MIH may include, in response to detecting a new MN, transmitting a Location Report signal to the mobile agent.

In another general aspect of the present invention, the processing of the MIH may include, in response to detecting a new MN, transmitting a Router Solicitation (RS) signal to the mobile agent.

In another general aspect of the present invention, the MN may be assigned with an IP address through a Dynamic Host Configuration Protocol (DHCP) process and configure network information.

In another general aspect of the present invention, the mobile agent may transmit to a Home Location Register (HLR) either a Proxy Binding Update (PBU) signal comprising an L2 ID and a Care of Address (CoA) of the connected MN or a Location Registration Request signal.

In another general aspect of the present invention, the HLR may configure a binding entry including an L2 IDs list, a connected CoA and a Prefix of the MN and then transmit to the mobile agent either a Proxy Binding Acknowledgement (PBA) signal or a Location Registration Acknowledgement signal.

In another general aspect of the present invention, the mobile agent may be assigned with either a Home of Address (HoA) or the Prefix to configure a binding entry including an L2 ID and the HOA and/or the Prefix and then transmit information on the HOA and/or the Prefix to the mobile router.

In another general aspect of the present invention, the mobility supporting method in the mobile router may further include performing a Media Independent Handover (MIH) follow-up operation to configure the binding entry including the L2 ID, the HoA and an IP address assigned through a DHCP response signal.

In another general aspect of the present invention, the MIH follow-up operation may include performing a Network Address Translation (NAT) process on data, which is received through a Correspondent Node (CN), with reference to the binding entry information managed by the mobile router and transmitting the data to the MN.

Accordingly, the present invention is capable of controlling mobility of an MN using a mobile router which acts as a wireless base station and an access router without modifying network infrastructures of an existing operator.

In addition, as the mobility supporting function is able to be performed in a cloud system, the mobile router may be responsible for a mobility control function, thereby leading to reduced costs for hardware of the MN and development of various services in association of network-based services.

### BRIEF DESCRIPTION OF THE DRAWINGS

FIG. 1 is a schematic view illustrating a network in which a mobility supporting method of a mobile router is applied according to an exemplary embodiment of the present invention;

FIG. 2 is a flowchart illustrating a mobility supporting method of a mobile router according to an exemplary embodiment of the present invention; and

FIG. 3 is a flow chart illustrating a mobility supporting method of a mobile router according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is delivered to assist the reader in gaining a comprehensive understanding of the methods, apparatuses, and/or systems described herein. Accordingly, various changes, modifications, and equivalents of the methods, apparatuses, and/or systems described herein will be understood by those of ordinary skill in the art. Also, descriptions of well-known functions and constructions may be omitted for increased clarity and conciseness.

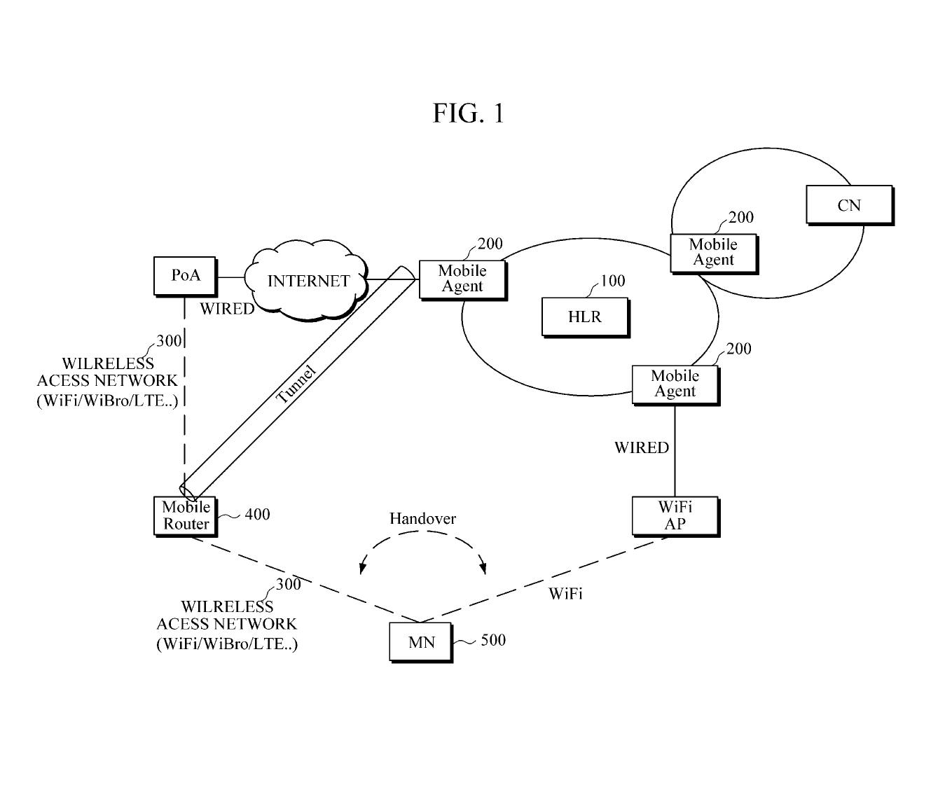

FIG. 1 is a schematic view illustrating a network in which a mobility supporting method of a mobile router is applied according to an exemplary embodiment. A service network for providing a seamless service when a Mobile Node (MN) 500 is moving includes a Home Location Register (HLR) 100 configured to control mobility, a mobile agent 200 and a wireless access network connected to the mobile agent 200.

A wireless access network such as WiFi, WiBro and LTE is connected not only to a core network but also to another access network through the mobile agent 200. In particular, if the wireless network does not support mobility of the MN 500, the MN 500 is connected to an existing access network through a mobile router 400 which supports mobility of the MN 500, thereby enabling to receive a seamless service when the MN 500 moves.

Specifically, the HLR 100 acts as a Media Independent Handover (MIH) server, a Home Subscriber Server (HSS), a Home Agent (HA), a Localized Mobility Agent or a Mobility Information & Control Server (MICS) in an existing mobility control protocol in order to manage location and handover of an MN and Mobility Independent Handover (MIH) information.

Specifically, the mobile agent 200 acts as a MIH Point of Service (PoS), a Foreign Agent (FA), a Mobile Access Gateway (MAG) or a Handover Control Agent (HCA) in the existing mobility control protocol in order to manage an MN's location and handover and process an MIH's event and a command.

The mobile router is physically configured to be connected to each Point of Attachment (PoA) of access networks in an up-stream processing while serving as a PoA of the MN in a down-stream processing. The mobile router technically acts as a mobility-supporting MN, a PoA and a Mobility Gateway.

The function performed as a mobility-supporting MN in network-based mobility control technologies includes a function of setting a Home of Address (HoA) and a Care of Address (CoA), instead of an MN, and a Media Independent Handover (MIH) function. The function performed as a PoA includes a Location Reporting function and a tunneling function, and the function performed as a Mobility Gateway includes managing a binding table and performing a Network Address Translation (NAT) process.

In the present invention, the above-described functions are defined as mobility proxies. Specifically, an MN-PoA mobility proxy is defined to describe a case where the mobility-supporting MN function and the PoA function are supported, and an MN-PoA-Gateway mobility proxy is defined to describe a case where the mobility-supporting MN function, the PoA function and the Mobility Gateway function are supported.

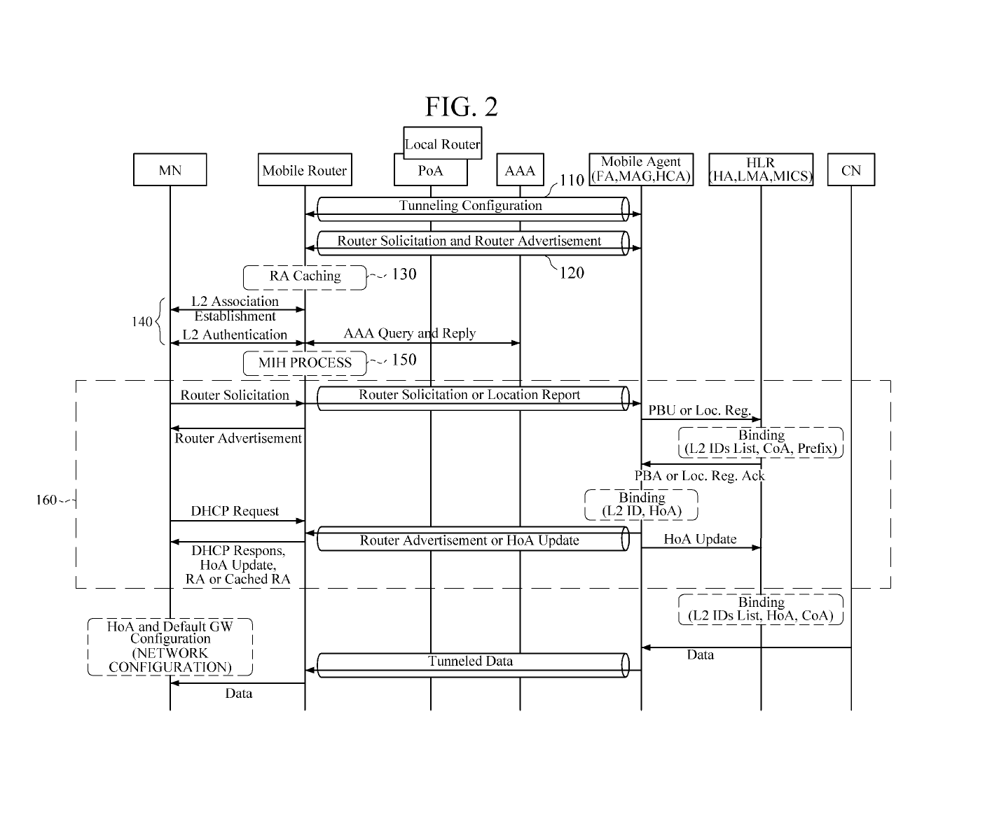

With reference to FIG. 2, mobility-supporting operations of a mobile router which acts as an MN-PoA mobility proxy are illustrated. FIG. 2 is a flow chart illustrating a mobility supporting method of a mobile router according to an exemplary embodiment of the present invention, and more specifically, location registration and data transmission using the function of the MN-PoA mobility proxy in order to support a handover.

The location registration is a process in which, regardless of whether an IP address has been set, an MN having no assigned HoA is connected to a network in order to register its location on the connected network and be assigned with an HOA.

Before the location registration, a mobile router configures a tunnel for transmitting a control signal and data to a mobile agent that manages an access network to which the MN is connected in 110.

Next, the mobile router transmits a Router Solicitation (RS) signal to the mobile agent and receives a Router Advertisement (RA) signal from the mobile agent in 120.

Next, if the RS signal is received from the MN, the mobile router caches the received RA signal to be transmitted to the corresponding MN in 130.

Next, the mobile router establishes a layer 2 (L2) association and performs an authentication process with respect to the MN in 140. The L2 association establishment is to connect the MN to an L2 layer of the mobile router.

The authentication process is to authenticate a user with respect to the MN. For example, if an International Mobile Subscriber Identry (IMSI) value stored in a USIM card of the MN is transmitted to a mobile router, the mobile router transmits an AAA query necessary for user authentication to an AAA server, which performs authentication, authorization and accounting functions, and receives the user authentication reply from the AAA server.

If a Media Independent Handover (MIH) occurs when the user authentication process has been completed, the mobile router processes the MIH in 150. At this time, the MIH may occur when a connection of a new MN is detected.

If the connection of the new MN is detected in 150 during which the MIH is processed, the mobile router transmits a Location Report signal including an L2 identification (L2 ID) value to the Mobile agent.

Meanwhile, if the RS signal is received from the MN, the RS signal is transmitted to the mobile agent according to a mobility control technique supported by the mobile router (such as, Mobile IP (MIP), Proxy Mobile IP(PMIP) and Access Interactive Mobile Services (AIMS)).

Meanwhile, in another general aspect, the mobility supporting method of a mobile router according to an exemplary embodiment of the present invention may further include a MIH follow-up operation 160. After the Location Report signal or the RS signal has been received in 150 during which the MIH is processed, the mobile router transmits a cached RA signal to the MN in the MIH follow-up operation 160.

Meanwhile, the mobile agent transmits to the HLR either a Proxy Binding Update (PBU) signal including an L2 ID, a Care of Address (CoA) and a Prefix of the connected MN or a Location Registration Request signal.

The HLR configures the binding entry including an L2 IDs list, a connected CoA and a Prefix of the MN, and transmits the binding entry to the mobile agent using either a Proxy Binding Acknowledgement (PBA) signal or a Location Registration Acknowledgement signal.

Specifically, the mobile agent is assigned with either a Home of Address (HoA) or the Prefix to configure the binding entry including the L2 ID and the HOA and/or the Prefix, and transmits information on the HOA and/or the Prefix to the mobile router using either an HOA update signal or the RA signal.

Meanwhile, the MN which has received the RA signal selectively transmits the request for a Dynamic Host Configuration Protocol (DHCP) to the mobile router. In response to the request for DHCP from the MN which has received the RA signal, the mobile router receives the information on the HoA and the Prefix from the mobile agent and transmits transmit the information on the HoA and the Prefix to the corresponding MN.

At this time, the mobile router may receive information on the HoA and the Prefix from the mobile agent using either the HoA update signal or the RA signal.

Next, the MN configures network information using the information on the HoA and the Prefix received from the mobile router. After that, data received from a Correspondent Node (CN) is transmitted to the MN through a tunnel configured between the mobile router and the mobile agent.

The mobile router operating as described above exchanges information with MIH Points of Service (PoS) when a handover occurs, thereby controlling mobility of an MN without modifying network infrastructures of an existing operator.

In addition, as mobility of an MN is able to be controlled in a cloud system, the mobile router may be responsible for a mobility-supporting function, thereby leading to reduced costs for hardware of the MN and development of various kinds of services in association of network- based services.

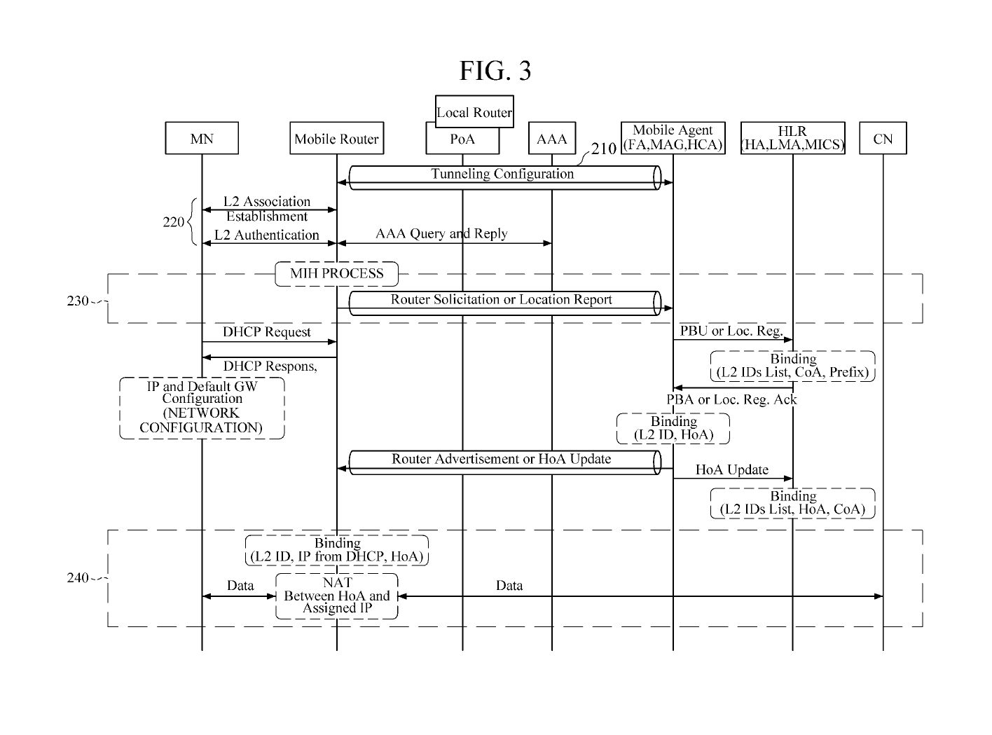

With reference to FIG. 3, mobility supporting operations of the mobile router which acts as an MN-PoA-Gateway mobility proxy are explained. FIG. 3 is a flow chart illustrating a mobility supporting method of a mobile router according to an exemplary embodiment of the present invention, and more specifically, location registration and data transmission using the function of the MN-PoA-Gateway mobility proxy in order to support a handover.

The location registration process is a process in which, regardless of whether an IP address has been set, an MN having no assigned HoA is connected to a network in order to register its location on the connected network and be assigned with an HOA.

Before the location registration, the mobile router, in 210, configures a tunnel for transmitting a control signal and data to a mobile agent that manages an access network to which the mobile router is connected.

The mobile router establishes L2 association and performs an authentication process with respect to the MN in 220. The L2 association establishment is to connect the MN to an L2.

The authentication process is to authenticate a user with respect to the MN. For example, if an International Mobile Subscriber Identry (IMSI) value stored in a USIM card of the MN is transmitted to the mobile router, the mobile router transmits an AAA query necessary for the user authentication to an AAA server which performs authentication, authorization and accounting functions, and receives the user authentication reply from the AAA server.

If a MIH occurs after the user authentication has been completed, the mobile router processes the MIH in 230. At this time, the MIH may occur when a new MN is detected.

If the new MN is detected in 230 during which the MIH is processed, the mobile router transmits to the mobile agent either a Location Report signal including an L2 ID value or an RS signal according to a mobility control technique supported by the mobile router (such as MIP, PMIP and AIMS).

Meanwhile, the MN is assigned with an IP address through a Dynamic Host Configuration Protocol (DHCP) process and configures network information, and the mobile agent transmits to a Home Location Register (HLR) either a PBU signal including an L2 ID, a CoA and a Prefix of the connected MN or a Location Registration Request signal.

The HLR configures a binding entry including an L2 IDs list, a connected CoA and a Prefix, and transmits the binding entry to the mobile agent using either a Proxy Binding Acknowledgement (PBA) signal or a Location Registration Acknowledgement signal.

Next, the mobile agent is assigned with either an HOA or the Prefix to configure the binding entry including an L2 ID and the HOA and/or the Prefix and transmits information on the HoA and/or the Prefix to the mobile router using an HOA update signal or a RA signal.

Next, the mobile router configures a binding entry including the L2 ID, the HOA and an IP address assigned through a DHCP response signal in a MIH follow-up operation 240. After that, the mobile router performs a Network Address Translation (NAT) process to transmit data received through a Correspondent Node (CN) to the MN based on binding entry information managed in the mobile router.

The mobile router operating as described above exchanges information with MIH Points of Service (PoS) when a handover occurs, thereby controlling mobility of an MN without modifying network infrastructures of an existing operator.

In addition, mobility of an MN is able to be controlled in a cloud system in order to leave the mobile router in charge of a mobility-supporting function, thereby leading to reduced costs for hardware of the MN and development of various kinds of services in association of network-based services.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A mobility supporting method of a mobile router, comprising:
configuring a tunnel for transmitting a control signal and data to a mobile agent configured to manage an access network to which a Mobile Node (MN) is connected;
transmitting a Router Solicitation (RS) signal to the mobile agent and receiving a Router Advertisement (RA) signal from the mobile agent;
caching the received RA signal to be transmitted to the MN upon receiving a RS signal from the corresponding MN;
establishing a layer-2 (L2) association and performing an authentication process with respect to the MN; and
in response to an occurrence of a Media Independent Handover (MIH), processing the MIH.

2. The mobility supporting method of claim 1, wherein the processing of the MIN comprises, in response to detecting a new MN, transmitting a Location Report signal to the mobile agent.

3. The mobility supporting method of claim 1, wherein the processing of the MIH comprises, in response to the RS signal received from the MN, transmitting the RS signal to the mobile agent.

4. The mobility supporting method of claim 1, further comprising:
performing a MIH follow-up operation to transmit to the MN the RA signal being cached by the mobile router.

5. The mobility supporting method of claim 4, wherein the MIH follow-up operation comprises, in response to a request for a Dynamic Host Configuration Protocol (DHCP) from the MN which has received the RA signal, receiving information on a Home of Address (HoA) and a Prefix from the mobile agent and transmitting the information on the HoA and the Prefix to the corresponding MN.

6. The mobility supporting method of claim 5, the MIH follow-up operation comprises receiving the information on the HoA and the Prefix from the mobile agent using either an HOA update signal or the RA signal.

7. The mobility supporting method of claim 5, wherein the mobile agent transmits to a Home Location Register (HLR) either a Proxy Binding Update (PBU) signal comprising an L2 ID and a Care of Address (CoA) of the connected MN or a Location Registration Request signal.

8. The mobility supporting method of claim 7, wherein the HLR configures a binding entry including an L2 IDs list, a connected CoA and a Prefix of the MN and then transmits the binding entry to the mobile agent using either a Proxy Binding Acknowledgement (PBA) signal or a Location Registration Acknowledgement signal.

9. The mobility supporting method of claim 8, wherein the mobile agent is assigned with either the HoA or the Prefix to configure the binding entry including the L2 ID and information on the HOA and/or the Prefix and transmits the information on the HOA and/or the Prefix to the mobile router.

10. The mobility supporting method of claim 5, wherein the MN configures network information using the information on the HoA and the Prefix received from the mobile router.

11. A mobility supporting method of a mobile router, comprising:
configuring a tunnel for transmitting a control signal and data to a mobile agent configured to manage an access network to which an MN is connected;
establishing L2 association and performing an authentication process with respect to the MN; and
in response to an occurrence of a Media Independent Handover (MIH), processing the MIH.

12. The mobility supporting method of claim 11, wherein the processing of the MIH comprises, in response to detecting a new MN, transmitting a Location Report signal to the mobile agent.

13. The mobility supporting method of claim 11, wherein the processing of the MIH comprises, in response to detecting a new MN, transmitting a Router Solicitation (RS) signal to the mobile agent.

14. The mobility supporting method of claim 11, wherein the MN is assigned with an IP address through a Dynamic Host Configuration Protocol (DHCP) process and configures network information.

15. The mobility supporting method of claim 14, wherein the mobile agent transmits to a Home Location Register (HLR) either a Proxy Binding Update (PBU) signal comprising an L2 ID and a Care of Address (CoA) of the connected MN or a Location Registration Request signal.

16. The mobility supporting method of claim 15, wherein the HLR configures a binding entry including an L2 IDs list, a connected CoA and a Prefix of the MN and then transmits to the mobile agent either a Proxy Binding Acknowledgement (PBA) signal or a Location Registration Acknowledgement signal.

17. The mobility supporting method of claim 16, wherein the mobile agent is assigned with either a Home of Address (HoA) or the Prefix to configure a binding entry including an L2 ID and the HOA and/or the Prefix and then transmits information on the HOA and/or the Prefix to the mobile router.

18. The mobility supporting method of claim 17, further comprising:
performing a MIH follow-up operation to configure the binding entry including the L2 ID, the HoA and an IP address assigned through a DHCP response signal.

19. The mobility supporting method of claim 18, wherein the MIH follow-up operation comprises performing a Network Address Translation (NAT) process on data, which is received through a Correspondent Node (CN), with reference to the binding entry information managed by the mobile router and transmitting the data to the MN.
